(19) United States
(12) Patent Application Publication
(10) Pub. No.: US 2012/0203413 A1
(43) Pub. Date: Aug. 9, 2012

(54) DATA BUS FOR A HYBRID VEHICLE

(75) Inventors: Markus Eisele, Friedrichshafen (DE); Patrick Breidenbach, Karlstadt (DE); Benjamin Winkler, Ludwigsburg (DE)

(73) Assignee: ZF FRIEDRICHSHAFEN AG, Friedrichshafen (DE)

(21) Appl. No.: 13/501,144

(22) PCT Filed: Oct. 19, 2010
(86) PCT No.: PCT/EP10/65696

§ 371 Date: Apr. 10, 2012

(30) Foreign Application Priority Data
Oct. 26, 2009 (DE) 10 2009 045 975.8

(51) Int. Cl. B60W 20/00

(52) U.S. Cl. 701/22; 903/902; 180/65.265

(57) ABSTRACT

A motor vehicle control system for a motor vehicle with a hybrid drive, with first control units, namely, at least one engine control unit associated with an internal combustion engine of the hybrid drive and a first diagnostic control unit, which send and receive diagnostic data and/or program data by way of a first data bus, and second control units, namely, at least one hybrid control unit associated with an electric machine of the hybrid drive and a second diagnostic control unit, which send and receive diagnostic data and/or program data by way of a second data bus. The hybrid control unit is connected to the first and second data buses and sends and receives diagnostic and/or program data via the buses, and the hybrid control unit converts protocols and/or contents of the diagnostic and/or program data bi-directionally between the first data bus and the second data bus.

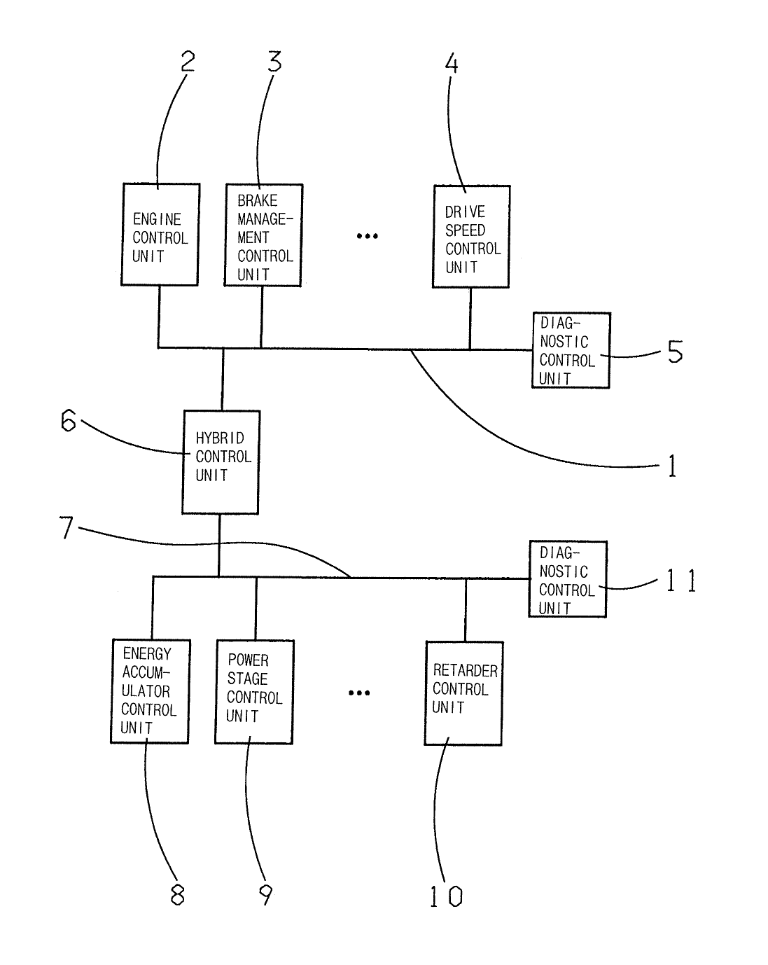

This application is a national stage completion of PCT/EP2010/065696 filed Oct. 19, 2010 which claims priority from German Application Serial No. 10 2009 045 975.8 filed Oct. 26, 2009.

### FIELD OF THE INVENTION

The invention concerns a control system for a motor vehicle with a hybrid drive as its drive assembly.

### BACKGROUND OF THE INVENTION

In conventional motor vehicles having exclusively an internal combustion engine as their drive assembly, all the vehicle's control devices are coupled to at least one common data bus so that the control devices send and/or receive data by way of the—or each—common data bus. The control devices on the—or each—common data bus are, in particular, an engine control unit, a diagnostic control unit, a brake management control unit and a control unit for regulating the driving speed.

By way of the—or each—data bus, the control devices send and receive as data, in particular, control data that serve actually to operate the control device concerned. As further data the control devices send and/or receive diagnostic data that serve for diagnosing the function of the control devices, and/or program data that serve for programming the control devices, the diagnostic data and/or program data being transmitted either via the same data bus as the control data, such a data bus then also being called a CAN data bus, or via a separate, diagnostic data bus.

In every case, however, in conventional motor vehicles all the control devices receive and send diagnostic data and/or program data by way of a common data bus, and for this all the control devices use a uniform protocol for data transmission.

In modern motor vehicles having as their drive assembly a hybrid drive with an internal combustion engine and at least one electric machine, in addition to the control devices of conventional motor vehicles there are further control devices, namely in particular control devices which are responsible for the electric-motor part of the drive-train of the hybrid drive.

In such a case the control devices responsible for the electric-motor part of the drive-train are connected to a second common data bus, which is also known as a hybrid CAN data bus, so that by way of this second data bus the control devices send and/or receive, in particular, diagnostic data and/or program data. For this, a second diagnostic control unit is connected to the second data bus, which serves for the function diagnosis and/or control unit programming of the control devices connected to the second data bus.

Accordingly, in modern motor vehicles with hybrid drives the motor vehicle control system is formed as a cascade structure with a plurality of data bus system, from which it follows that a superordinate diagnosis of all the control devices is not readily possible. There is therefore a need for a motor vehicle control system for a motor vehicle with a hybrid drive, with which a superordinate diagnosis of cascaded control devices connected to different data bus systems is made possible in a simple manner.

### SUMMARY OF THE INVENTION

Starting from there, the present invention addresses the problem of providing a new type of motor vehicle control system for a motor vehicle with a hybrid drive.

According to the invention, the hybrid control system is connected on the one hand to the first data bus and on the other hand to the second data bus, and by way of these sends and/or receives diagnostic data and/or program data, whereas the hybrid control system converts protocols and/or the contents of the diagnostic data and/or the program data bi-directionally between the first and second data buses.

With the present invention it is proposed that the hybrid control system serves as a central interface for diagnostic and/or program data between control units connected to a first data bus and control units connected to a second data bus. To the first data bus are connected control units also built into conventional motor vehicles. To the second data bus are connected control units that have to do in particular with the electric motor drive-train part of the motor vehicle. The hybrid control system itself is connected both to the first and to the second data bus, and provides a central interface for diagnostic data and/or program data of the cascaded motor vehicle control system, wherein the hybrid control unit converts protocols and/or contents of the diagnostic data and/or program data bi-directionally between the first and/or the second data buses.

The motor vehicle control system according to the invention allows a superordinated, central diagnosis and/or programming of all the control units built into a motor vehicle with a hybrid drive system. Since the hybrid control unit serves as a central interface, changes in the sense of reprogramming in order to ensure the bi-directional conversion of protocols and/or contents only have to be made at the hybrid control unit. All other control units can remain unchanged.

### BRIEF DESCRIPTION OF THE DRAWING

Preferred further developments of the invention emerge from the subordinate claims and from the description below. An example embodiment of the invention, to which it is not limited, is explained in more detail with reference to the sole drawing, which shows a block diagram to make clear the motor vehicle control system according to the invention.

### DETAILED DESCRIPTION OF THE INVENTION

The present invention concerns a motor vehicle control system for a motor vehicle having a hybrid drive. A hybrid drive comprises an internal combustion engine, an electric machine and an electrical energy accumulator, such that the electric machine of the hybrid drive can be operated as a motor and as a generator. When the electric machine operates as a motor it discharges the electrical energy accumulator and transforms the electrical energy into mechanical energy. When the electric machine operates as a generator it charges the electrical energy accumulator by transforming mechanical energy into electrical energy.

The FIGURE shows the basic structure of a motor vehicle control system according to the invention for a motor vehicle with a hybrid drive, wherein first control units 2, 3, 4 and 5 are connected to a first data bus 1. The control units 2, 3, 4 and 5 are ones which can also be built into motor vehicles with a conventional drive, such as an engine control unit 2 for controlling and/or regulating an internal combustion engine, a brake management control unit 3 for controlling and/or regulating braking processes, a control unit 4 for regulating the driving speed of the vehicle, and a first diagnostic control unit 5. The control units 2, 3, 4 and 5 send and/or receive data by way of the first data bus 1, such as also the diagnostic data and/or program data, the diagnostic data serving for function diagnosis and the program data for programming the control units.

Besides the first control units 2, 3, 4 and 5, the control unit structure in the FIGURE also comprises a first hybrid control unit 6 which is also connected to the first data bus 1 and which sends and/or receives diagnostic and/or program data by way of the first data bus 1. The hybrid control unit 6 is associated in particular with the electric machine of the hybrid drive in order to control and/or regulate the operation of the electric machine.

According to the FIGURE, subordinate to the hybrid control unit 6 connected to the first data bus 1 there are second control units 8, 9, 10 and 11, and for that purpose the hybrid control unit 6 and the second control units 8, 9, 10 and 11 are connected to a second data bus 7. The control units 6, 8, 9, 10 and 11 send and/or receive data, such as diagnostic data and/or program data, by way of the second data bus 7.

The control units connected to the second data bus 7 are control units which are associated in particular with the electric motor part of the vehicle's drive-train and which serve for the control and/or regulation of the electric motor part of the drive-train. Thus, the second control unit 8 can be a control unit for an electrical energy accumulator of the hybrid drive system. The control unit 9 can be a control unit for a power stage of the electric machine. The control unit 10 can be a control unit of a retarder. The control unit 11 is a second diagnostic control unit, in order to carry out function diagnosis and/or control unit programming of the control units connected to the second data bus 7.

Control units for the transmission can be connected to the first data bus 1 and/or to the second data bus 7.

With such a cascaded control unit structure, in order to be able to carry out, with the control units 8, 9 and 10 subordinated to the hybrid control unit 6, a central diagnosis and/or control unit programming, it is proposed according to the invention that the hybrid control unit 6, which is connected on the one hand to the first data bus 1 and on the other hand to the second data bus 7 and which sends and/or receives diagnostic data and/or program data by way of the same, should function as the central interface for diagnostic and/or program data between the data bus 1 and the data bus 7, and in this connection convert protocols and/or contents of the diagnostic and/or program data bi-directionally between the first data bus 1 and the second data bus 7.

Accordingly, it is possible for the first diagnostic control unit 5 to send, by way of the first data bus 1, diagnostic and/or program data for the second control units 8, 9 and 10 coupled to the second data bus 7, which the hybrid control unit 6 then receives, converts, and sends to the control units, 8, 9 and 10 by way of the second data bus 7. Likewise, it is possible for the control units 8, 9, 10 and 11 connected to the second data bus 7 to send diagnostic and/or program data by way of the data bus 7, which the hybrid control unit 6 then receives, converts, and supplies to the control units 2, 3, 4 and 5 by way of the first data bus 1.

The control units 2, 3, 4, 5 and 6 are coupled directly to the first data bus 1. The control units 8, 9, 10 and 11 are coupled directly to the second data bus 7 and indirectly, by way of the hybrid control unit 6, to the first data bus 1. Likewise, the control units 2, 3, 4 and 5 are coupled indirectly, by way of the hybrid control unit 6, to the second data bus 7.

The hybrid control unit forms a central interface between the first data bus 1 and the second data bus 7, or between the control units 2, 3, 4 and 5 connected to the first data bus 1 and the control units 8, 9, 10 and 11 connected to the second data bus 7, such that for this purpose the hybrid control unit 6 converts protocols and/or contents of the diagnostic and/or program data bi-directionally.

The motor vehicle control system according to the invention enables on-board control unit diagnosis during normal operation of the motor vehicle as well as off-board control unit diagnosis during a visit to a workshop. Furthermore, program data for the programming of the control units can be handled.

The first data bus 1 and the second data bus 7 shown in the FIGURE can in each case be either a separate diagnostic data bus via which exclusively diagnostic data and/or program data are sent and/or received, or they can be a data bus by way of which control data as well can be transmitted.

### INDEXES

1 First data bus
2 First control unit/engine control unit
3 First control unit/brake management control unit
4 First control unit
5 First control unit/first diagnostic control unit
6 Hybrid control unit
7 Second data bus
8 Second control unit/electrical energy accumulator control unit
9 Second control unit/power stage control unit
10 Second control unit
11 Second control unit/second diagnostic control unit

1-7. (canceled)

8. A motor vehicle control system for a motor vehicle with a hybrid drive, the control system comprising:
first control units (2, 3, 4, 5, 6) comprising at least one engine control unit associated with an internal combustion engine of the hybrid drive and a first diagnostic control unit, and the first control units sending and receiving at least one of diagnostic data and program data by way of a first data bus (1);
second control units (8, 9, 10, 11) comprising at least one hybrid control unit associated with an electric machine of the hybrid drive and a second diagnostic control unit, and the second control units sending and receiving at least one of diagnostic data and program data by way of a second data bus (7); and
the hybrid control unit (6) being connected to the first data bus (1) and to the second data bus (7) for sending and receiving at least one of diagnostic and program data via the first and the second data buses (1, 7), and the hybrid control unit (6) converting at least one of protocols and contents of at least one of diagnostic date and program data bi-directionally between the first data bus (1) and the second data bus (7).

9. The motor vehicle control system according to claim 8, wherein the engine control unit (2), the hybrid control unit (6), the first diagnostic control unit (5), a brake management control unit (3) and at least one further control unit (4) of at least one of the internal combustion engine and a transmission portion of a drive-train, send and receive at least one of diagnostic data and program data by way of the first data bus (1).

10. The motor vehicle control system according to claim 8, wherein the hybrid control unit (6), the second diagnostic unit (11), a control unit (8) of an electrical energy accumulator of the hybrid drive and at least one further control unit (9, 10) of at least one of an electric motor and a transmission portion of a drive-train, send and receive at least one of diagnostic data and program data by way of the second data bus (7).

11. The motor vehicle control system according to claim 8, wherein the first diagnostic control unit (5) sends, by way of the first data bus (1), at least one of diagnostic data and program data for the second control units (8, 9, 10, 11) coupled indirectly, via the hybrid control unit (6), to the first data bus (1),
the hybrid control unit (6) receives at least one of diagnostic data and program data, converts at least one of protocols and contents of the at least one of the diagnostic data and the program data centrally for all of the second control units (8, 9, 10, 11) connected indirectly, via the hybrid control unit (6), to the first data bus (1), and then sends at least one of converted diagnostic data and program data by way of the second data bus (7).

12. The motor vehicle control system according to claim 8, wherein the second control units (8, 9, 10, 11), connected indirectly to the first data bus (1) via the hybrid control unit (6), send at least one of diagnostic data and program data by way of the second data bus (7), the hybrid control unit (6) receives the at least one of diagnostic data and program data, converts at least one of protocols and contents of the at least one of diagnostic data and program data centrally for all the control units (2, 3, 4, 5) coupled indirectly, via the hybrid control unit (6), to the second data bus (7), and then sends at least one of converted diagnostic data and program data by way of the first data bus (1).

13. The motor vehicle control system according to claim 8, wherein the diagnostic data are processed for at least one of an on-board control unit diagnosis and an off-board control unit diagnosis.

14. The motor vehicle control system according to claim 8, wherein the program data for the programming of the control units are processed in the above manner.
